(19) United States
(12) Patent Application Publication
(10) Pub. No.: US 2013/0080244 A1
(43) Pub. Date: Mar. 28, 2013

(54) METHOD AND A SYSTEM FOR MANAGING ADVERTISING CAMPAIGNS

(71) Applicant: SITECORE A/S, Kobenhavn V (DK)

(72) Inventor: Ralph Ronald PERSON, Santa Rosa, CA (US)

(73) Assignee: SITECORE A/S, Kobenhaven V (DK)

(21) Appl. No.: 13/624,439

(22) Filed: Sep. 21, 2012

Related U.S. Application Data
(60) Provisional application No. 61/537,886, filed on Sep. 22, 2011.

(51) Int. Cl. G06Q 30/02

(52) U.S. Cl. 705/14.43

(57) ABSTRACT

In a method and a system for managing advertising campaigns, a plurality of advertising campaigns is launched, and a plurality of visitors is allowed to visit a website. The behavior of the visitors is monitored, a value point score is obtained for each visit, and each visit is designated to an advertising campaign. For each advertising campaign an accumulated value point score and the number of visits designated to the advertising campaign are calculated. The advertising campaigns are compared, including comparing the accumulated value point scores and the number of visits. The comparison may include comparing attributes, elements or themes of the advertising campaigns. Based on the comparison a new advertising campaign is planned. Since the new advertising campaign is designed with consideration to the actual impact of previous advertising campaigns on the generated value, the new advertising campaign is very likely to fulfill specific marketing goals or strategies.

### FIELD OF THE INVENTION

The present invention relates to a method and a system for managing advertising campaigns, e.g. web-based advertising campaigns. The method of the invention may be a computer-implemented method. The method and system of the invention may be used for optimizing advertising campaigns and/or for focusing marketing efforts on value-generating activities. Throughout this patent application the term advertising campaign will include advertising campaigns as known in the industry as well as other more broadly defined ‘marketing efforts’.

### BACKGROUND OF THE INVENTION

For website owners it is often desirable to maximize the value of visits performed on the website. It may also be desirable to increase the traffic to the website. In order to achieve this, website owners sometimes launch advertising campaigns, designed to lead visitors to the website. The advertising campaigns may be directed towards groups of potential visitors which the website owner in particular wants to visit the website, e.g. because visitors belonging to such groups are expected to exhibit a behaviour during their visits to the website which tends to generate high value for the website owner.

When advertising campaigns are launched, as described above, it may be desirable for the website owner to gain knowledge regarding the impact or efficiency of the advertising campaigns. It may also be desirable to use such knowledge for designing future advertising campaigns.

U.S. Pat. No. 8,000,994 B2 discloses a computer-implemented system and method for web activity assessment. Data about customer activity is received and is used to generate actual data values associated with preselected business metrics. One or more business metric score cards may be generated to assess how the business metrics are performing as well as what business metrics can be changed to better meet business goals.

US 2005/0289005 A1 discloses systems and methods of achieving optimal advertising. Small quantities of experimental advertising banner designs are tested to extract valuable information from the experiments. The systems and methods may incorporate array mathematics that improves the results of the overall advertising campaigns.

US 2009/0265221 A1 discloses systems, methods and apparatus for analyzing the influence of marketing assets. The influence of marketing assets upon an individual are analyzed. In particular, a record of the individual's interactions with a first marketing asset of a first marketing campaign may be stored in a database. Thereafter, the database may be queried to determine whether the individual interacted with the first marketing asset in accordance with defined criteria. If so, the individual may be associated with the first marketing campaign.

### DESCRIPTION OF THE INVENTION

It is an object of embodiments of the invention to provide a method for managing advertising campaigns, the method allowing a marketer to design a future advertising campaign, based on knowledge regarding actual impact of previous advertising campaigns.

It is a further object of embodiments of the invention to provide a method for managing advertising campaigns, the method providing information regarding actual impact of previous advertising campaigns, without requiring excessive amounts of data and/or excessive amounts of calculations.

It is an even further object of embodiments of the invention to provide a system for managing advertising campaigns, the system allowing a marketer to design a future advertising campaign, based on knowledge regarding actual impact of previous advertising campaigns.

It is an even further object of embodiments of the invention to provide a system for managing advertising campaigns, the system producing information regarding actual impact of previous advertising campaigns, without requiring excessive amounts of data and/or excessive amounts of calculations.

As mentioned above, the term ‘advertising campaign’ should be interpreted to cover advertising campaigns as known in the industry as well as other more broadly defined ‘marketing efforts’.

According to a first aspect the invention provides a method for managing advertising campaigns, the method comprising the steps of:
launching a plurality of advertising campaigns,
allowing a plurality of visitors to visit a website, said website being arranged on a server,
for each visit:
   designating the visit to an advertising campaign,
   monitoring navigations and/or actions performed by the visitor during the visit while accumulating value points in accordance with content viewed by the visitor and actions performed by the visitor, and in accordance with predefined value point settings associated with content of the website, thereby obtaining a value point score for the visit,
for each advertising campaign:
   calculating an accumulated value point score for the advertising campaign as the sum of value point scores for all visits designated to the advertising campaign,
   calculating the number of visits designated to the advertising campaign,
comparing the plurality of advertising campaigns, including comparing accumulated value point scores and number of visits for the plurality of advertising campaigns, and
based on the comparing step, planning a new advertising campaign.

In the present context the term ‘advertising campaign’ should be interpreted to mean a campaign which promotes a company, a website, one or more specific products, etc. An advertising campaign may include advertising e-mails, banner ads, TV spots, newspaper ads, and/or any other suitable kind of distributing media or marketing efforts. An advertising campaign may advantageously be limited in time, it may promote a specific product or a specific website, and/or it may relate to a specific theme. For instance, a given advertising campaign may comprise various marketing efforts which all promote the same product and/or ‘tell the same story’, for instance referring to a specific survey or an article praising the product or the company owning the website, or using the same catchphrase.

According to the method of the first aspect of the invention, a plurality of such advertising campaigns is initially launched, i.e. a marketer initiates a plurality of such campaigns, either simultaneously or sequentially, possibly directing the campaigns at specific target groups, and possibly choosing various distribution channels or themes for the campaigns. Following this, a plurality of visitors is allowed to visit a website.

In the present context the term ‘visitor’ should be interpreted to mean an individual visiting the website, navigating within the website and performing actions within the website.

In the present context the term ‘website’ should be interpreted to mean a collection of related web pages, images, videos or other digital assets being addressed relative to a common Uniform Resource Locator (URL). The web pages of the website may advantageously be designed, presented and linked together to form a logical information resource and/or transaction initiation function. According to the first aspect of the invention, the website being visited is arranged on, or hosted on, a server. The server, and thereby the website, is typically accessible via a data network, such as the Internet or a Local Area Network (LAN). It should be noted that, in the present context, the term ‘server’ should be interpreted to cover a single device as well as two or more individual devices being interlinked in such a manner that they, to a visitor of the website, seem to act as a single device.

For each visit, the visit is designated to an advertising campaign. Thus, for each visit it is determined, from which advertising campaign the visit originated. It should be noted that this step may also include identifying visits which did not originate from an advertising campaign, e.g. visits which were directed to the website by the visitor keying the URL of the website directly into a browser, or visits which originated from a search performed by means of a search engine. Such visits will not be used when performing the data processing described below.

When designating a visit to an advertising campaign, information regarding the origin of the visit, i.e. information regarding how and/or from where the visitor arrived at the website, may advantageously be used. For instance, it may be registered that the visitor activated a link attached to an e-mail forming part of an e-mail campaign, that the visitor clicked a banner ad, that a visitor entered a code or a URL specified in a TV spot or a printed ad, etc. Alternatively or additionally, visitors visiting the website during a specific time interval may be designated to an advertising campaign running during this time interval.

During each visit, navigations and/or actions performed by the visitor are monitored, while accumulating value points. Value point settings have previously been associated with content of the website, and the value points of the visit are accumulated in accordance with these settings, and in accordance with the navigations and/or actions performed by the visitor. Thus, when a visitor encounters a specific piece of content during the visit, the value points are adjusted with an amount corresponding to the value point setting associated with that piece of content.

In the present context the term ‘content’ should be interpreted to include anything which a visitor may experience during a visit to the website, including content presented to the visitor, such as web pages, images, video sequences, audible sequences, etc., actions performed by the visitor, including forms being filled in, searches performed within the website, tests, polls, etc., or any other kind of content which the visitor may experience or encounter during a visit to the website.

The predefined value point settings may reflect value obtained by the owner of the website due to navigations and/or actions performed by the visitor during the visit. In this case, the website owner or manager defines the value point settings in such a manner that navigations and/or actions which the website owner wants the visitor to perform and/or which generate value for the owner of the website, generate a high value point score. Accordingly, a high value point score for a visit indicates that the website owner gained a lot of value from the visit. Alternatively or additionally, the value point settings may reflect value generated for the visitor. If the visitor experiences that the visit is valuable, he or she might want to prolong the visit and/or to return to the website at a later point in time. Examples of high value behaviour may include, but are not limited to, purchasing a product via the website, requesting a web based demo, ordering a catalogue, requesting a personal contact, visiting at least a predefined number of web pages of the website, etc. Alternatively or additionally, the value point settings may reflect the commitment of the visitor, in which case a high value point setting reflects a high commitment by the visitor to the website. A high commitment could, e.g., be a visitor requesting an instant demo or live demonstration, thereby allowing the website owner to perform two-way communication with the visitor.

Accordingly, at the end of the visit, a value point score for the visit has been obtained, which reflects the value points ‘collected’ by the visitor during the visit. If the value point settings are selected and assigned in an appropriate manner, the value point score may reflect the value which the visit generated for the website owner, i.e. it is a measure for how valuable the visit was. Since the visit has also been designated to an advertising campaign, as described above, the value point score for the visit is also associated with or designated to the advertising campaign.

Once information has been collected, as described above, for a plurality of visits to the website, the collected information is analysed. This includes, for each advertising campaign, calculating an accumulated value point score and calculating the number of visits designated to the advertising campaign. The accumulated value point score is calculated as the sum of value point scores for all visits designated to the advertising campaign. Accordingly, the accumulated value point score for a given advertising campaign represents the total value generated for the website owner during all of the visits which were designated to that advertising campaign. Thus, the accumulated value point score is a measure for the value or return of investment of the advertising campaign. Furthermore, this measure is obtained from the actual behaviour of actual visitors to the website, not on the basis of field studies, market research, inference of visitor intent, etc. Accordingly, the accumulated value point score provides valuable information regarding the actual impact of an advertising campaign on the value generated for the website owner.

Next, the plurality of advertising campaigns is compared. This includes comparing the accumulated value point scores and the number of visits for the plurality of advertising campaigns. This comparison reveals which advertising campaigns result in high/low number of visits, and which advertising campaigns result in high/low accumulated value point scores. This information can be used for designing a future advertising campaign in a manner which supports an overall marketing strategy for the website owner. For instance, the website owner may want to obtain a high number of visitors to the website, but is not particularly interested in a high value point score for each visit. In this case, advertising campaigns with high number of visits can be compared with advertising campaigns with low number of visits, in order to identify attributes, elements or themes of the campaigns which appear to have resulted in high or low number of visitors. Such identification can, e.g., be obtained by comparing attributes, elements or themes of the previous advertising campaigns. A future advertising campaign can then be designed with attributes, elements or themes which seem to increase the number of visits and without attributes, elements or themes which seem to decrease (or at least not increase) the number of visits.

Similarly, the website owner may want to focus future marketing efforts on visitors which generate high value for the website owner. In this case, advertising campaigns with high accumulated value point scores, possibly with low number of visitors, may be compared with advertising campaigns with low accumulated value point scores.

In summary, advertising campaigns which seem to fulfil the marketing goals or strategies of the website owner can be compared with advertising campaigns which apparently do not fulfil these goals or strategies, or which even seem to counteract these goals or strategies, thereby allowing a marketer to design a future advertising campaign which is likely to fulfil the marketing goals or strategies. As described above, this is obtained on the basis of actual behaviour of actual visitors to the website, and without requiring an excessive amount of data. When comparing the advertising campaigns, attributes, elements or themes of the advertising campaigns may be compared.

At least one of the advertising campaigns may be a web-based advertising campaign. In the present context the term ‘web-based advertising campaign’ should be interpreted to mean an advertising campaign which is distributed via the Internet, e.g. including e-mail campaigns, banner ads, etc.

The method may further comprise the step of generating a graphical representation of the accumulated value point scores and number of visits for the plurality of advertising campaigns, and the step of comparing may be performed using the generated graphical representation. The graphical representation allows a marketer to gain a quick overview of the advertising campaigns, including how many and which advertising campaigns seem to fulfil the marketing goals or strategies of the website owner, as well as how many and which advertising campaigns seem to not fulfil these goals or strategies. This makes it easy for the marketer to determine which advertising campaigns to compare in order to obtain information regarding which attributes, elements or themes to include/exclude in/from a future advertising campaign, in order to obtain a desired effect of the future advertising campaign.

The graphical representation may comprise a matrix representation. The matrix representation may, e.g., be similar to a Boston Consulting Group Matrix, e.g. plotting the advertising campaigns in a two-dimensional structure with number of visits along one axis and accumulated value point scores along a second, perpendicular, axis. The graphical representation may further be divided into four quadrants, representing low number of visitors and low accumulated value point scores, high number of visitors and low accumulated value point scores, low number of visitors and high accumulated value point scores, and high number of visitors and high accumulated value point scores, respectively. In this case the graphical representation immediately reveals to a marketer how the advertising campaigns are distributed among the four quadrants of the matrix.

Quadrants may be separated by different criteria as defined by the marketers. For example, the average of all visits might define a vertical separator and the average of accumulated values might define the horizontal separator. In a different scenario marketers might define the separators as an average plus one standard deviation. The position of the quadrant separators is dependent upon how refined the marketer wishes to separate the quadrants.

The four quadrants described above may each represent a segment of visitors or potential visitors. For instance, the quadrant representing low number of visitors and low accumulated value point scores may represent ‘Passives’, in the sense that the advertising campaigns of this quadrant produced very few visits as well as very low value. This visitors of this quadrant may, alternatively, be referred to as ‘Dogs’. Accordingly, these advertising campaigns had a very poor return on investment.

As another example, the quadrant representing high number of visitors and low accumulated value point scores may represent ‘Attractors’, in the sense that the advertising campaigns of this quadrant were successful in attracting a large number of visitors to the website. However, the accumulated value was not high, so the value might actually be the same as for ‘Passives’, but ‘Attractors’ have attracted a large number of visitors so a small increase in the conversion rate will add a significant amount of value to the website. Marketers now know that advertising campaigns in the ‘Attractor’ quadrant are effective in attracting visitors, but they need to increase their effectiveness in conversion. With this knowledge marketers can use lists of best practices for improving conversion rates for advertising campaigns in this quadrant.

As yet another example the quadrant representing low number of visitors and high accumulated value point scores may represent ‘Converters’, in the sense that the advertising campaigns of this quadrant were successful in generating high value point scores. However, the number of visits was not high, so the value/visit might be high, but it did not affect many visits. Increasing the number of visits would add a significant amount of value to the website. Marketers now know that advertising campaigns in the ‘Converter’ quadrant are effective in converting visitors and adding value, but they need to be more attractive. With this knowledge marketers can use lists of best practices for improving attractiveness of advertising campaigns in this quadrant.

Finally, as yet another example the quadrant representing high numbers of visitors and high accumulated value point scores may represent ‘Heroes’, in the sense that the advertising campaigns of this quadrant succeeded in attracting a high number of visitors, as well as in attracting visitors which generated high value point scores. This quadrant may also be referred to as ‘Stars’. With this knowledge marketers know they should repeat, extend, and leverage advertising campaigns in the ‘Heroes’ quadrant to continue to generate more visits and value.

Based on the four quadrants, a marketing goal or strategy for a new advertising campaign can be selected. In most cases it may be found that moving high ‘Attractor’ or ‘Converter’ campaigns to push them toward the ‘Heroes’ quadrant is the most efficient way to improve marketing results. Conversely, after a sufficient amount of time, advertising campaigns that remain in the ‘Passives’ quadrant may have shown they are ineffective and they should be stopped. The effort to move ‘Passives’ into the ‘Attractor’ or ‘Converter’ quadrants will most probably take far more effort than moving an ‘Attractor’ or ‘Converter’ into the ‘Heroes’ quadrant. In this way marketers know that focusing their efforts on campaigns that are close to become ‘Heroes’ can produce greater results. Thus, the matrix representation can be used for actively defining a marketing goal for a future advertising campaign.

In order to fulfil a marketing goal for a future advertising campaign, once the goal is defined as described above, the representation of the previous advertising campaigns in the matrix helps the marketer in figuring out how to fulfil the marketing goal. For instance, the marketer may compare the advertising campaigns of the ‘Passives’ quadrant and the ‘Converters’ quadrant with the advertising campaigns of the ‘Attractors’ quadrant and the ‘Heroes’ quadrant. This may reveal why the advertising campaigns of the ‘Attractors’ quadrant and the ‘Heroes’ quadrant were successful in attracting visitors to the website, while the advertising campaigns of the ‘Passives’ quadrant and the ‘Converters’ quadrant were not.

This step may advantageously include comparing various attributes or elements of the advertising campaigns. A marketing protocol can be developed that identifies specific attributes of advertising campaigns or marketing efforts. Using appropriate mathematics, attributes of ‘Attractors’, ‘Converters’, and ‘Heroes’ can be identified and differentiated from one another, i.e., attributes of an ‘Attractor’ might be applied to advertising campaigns that are ‘Converters’. The result would be to push the former ‘Attractor’ campaign into becoming a ‘Heroes.’ Once attributes are identified that drive attraction and drive conversion, these identified attributes can be used as best practices for the development of new advertising campaigns. Such attributes might be advertising elements such as topic words, colors, button positions, traffic channels, and so forth.

When planning the new advertising campaign, successful attributes, elements or themes from the previous advertising campaigns of the ‘Attractors’ quadrant and the ‘Heroes’ quadrant may be applied, while unsuccessful attributes, elements or themes from the previous advertising campaigns of the ‘Passives’ quadrant and the ‘Converters’ quadrant are left out. Thereby there is a high likelihood that the new advertising campaign will be successful in attracting visitors to the website, i.e. in increasing the number of visitors. In a similar manner, the new advertising campaign may be designed in a manner which increases the average value point score generated by each visit, by comparing attributes, elements or themes of the previous advertising campaigns and carefully selecting attributes, elements or themes which appear to increase the generated value per visit.

Thus, the step of planning a new advertising campaign may comprise reusing attributes or elements from one or more of the plurality of advertising campaigns, i.e. from the previous advertising campaigns, based upon the discoveries of how attributes affect results.

The comparing step may comprise categorising each of the plurality of advertising campaigns, based on the accumulated value point scores and the number of visits. The categorising may, e.g., include categorising the advertising campaigns into the four quadrants described above. However, other categories may be used, and they may not be linked to an embodiment in which a graphical representation is generated.

The comparing step may be performed by a comparing module, and the method may further comprise the step of the comparing module suggesting at least one course of action for a new advertising campaign, based on the comparing step. According to this embodiment, a comparing module automatically generates a suggestion to the marketer, regarding how to design a future advertising campaign in such a manner that a defined marketing goal is obtained. The suggestion is based on the comparison of the previous advertising campaigns, the comparison preferably including comparing attributes, elements or themes of the previous advertising campaigns. Accordingly, the comparing module helps the marketer in extracting possible valuable features of the previous advertising campaigns which may advantageously be reused in a future advertising campaign. Such possible valuable features may, e.g., include attributes, elements or themes of the advertising campaigns, distribution channels, target groups, etc. However, it is still the marketer who designs the future advertising campaign, but the suggestions of the comparing module may be a valuable help in doing so.

The comparing step may be performed using artificial intelligence, such as a neural network. According to this embodiment, the comparing module is continuously improving the performed comparison, and thereby the suggestion is made by the comparing module, based on previous experience, and possibly feedback from the marketer. For instance, by means of artificial intelligence, the comparing module may ‘gain knowledge’ regarding which attributes or elements of the advertising campaigns seem to be successful with respect to fulfilling specific marketing goals or strategies.

The suggesting step may comprise identifying one or more campaigns and/or one or more attributes or elements of a campaign to be changed. According to this embodiment, the comparing module searches for campaigns and/or attributes or elements of campaigns which appear to have a negative impact with respect to an identified marketing goal. Once such campaigns, attributes or elements have been identified, the comparing modules present them to the marketer, thereby allowing the marketer to improve these campaigns, attributes or elements in such a manner that the identified marketing goal can be obtained.

According to a second aspect the invention provides a system for managing advertising campaigns, the system comprising:
a server having a website arranged thereon,
a monitoring module adapted to monitor navigations and/or actions performed by a visitor during a visit to the website, said monitoring module further being adapted to accumulate value points in accordance with content viewed by the visitor and actions performed by the visitor, and in accordance with predefined value point settings associated with content of the website, thereby obtaining a value point score for the visit, and being adapted to designate the visit to an advertising campaign,
a calculating module adapted to calculate, for each of a plurality of previously launched advertising campaigns, an accumulated value point score, being the sum of value point scores for visits designated to the advertising campaign, and the number of visits designated to the advertising campaign,
a graphical representation module adapted to generate a graphical representation of accumulated value point scores and number of visits for the plurality of advertising campaigns.

It should be noted that a person skilled in the art would readily recognise that any feature described in combination with the first aspect of the invention could also be combined with the second aspect of the invention, and vice versa.

The system according to the second aspect of the invention may advantageously be used for performing the method according to the first aspect of the invention, and the remarks set forth above with reference to the first aspect of the invention are therefore equally applicable here.

The system may further comprise a comparing module adapted to compare accumulated value point scores and number of visits for the plurality of advertising campaigns. The comparing module preferably cooperates with the graphical representation module in such a manner that the graphical representation module is adapted to generate a graphical representation of the result of the comparison performed by the comparing module. The comparing module may further be adapted to compare attributes or elements of the advertising campaigns, as described above.

The comparing module may further be adapted to generate a suggestion for at least one course of action for a new advertising campaign, based on a comparison performed by the comparing module. According to this embodiment, the comparing module provides guidance for a marketer with respect to how to design a future advertising campaign in such a manner that a specific marketing goal or strategy is likely to be obtained. However, the final decision regarding the design of the future advertising campaign is still taken by the marketer.

The comparing module may be adapted to perform comparison by means of artificial intelligence, such as by means of a neural network. According to this embodiment, the comparison performed by the comparing module is continuously improved, based on previously performed comparisons.

The system may further comprise an advertising planning module arranged to plan a new advertising campaign based on a graphical representation generated by the graphical representation module. The system according to this embodiment is a fully automatic system which is adapted to collect information regarding the impact of a plurality of advertising campaigns on the value generated for a website owner, analysing the collected information, and planning a new advertising campaign, based on the performed analysis.

### BRIEF DESCRIPTION OF THE DRAWINGS

The invention will now be described in further detail with reference to the accompanying drawings, in which

FIG. 1 is a diagrammatic view of a system according to a first embodiment of the invention,

FIG. 2 is a diagrammatic view of a system according to a second embodiment of the invention,

FIG. 3 is a graphical representation generated by a system according to an embodiment of the invention, and

FIG. 4 is a flow diagram illustrating a method according to an embodiment of the invention.

### DETAILED DESCRIPTION OF THE DRAWINGS

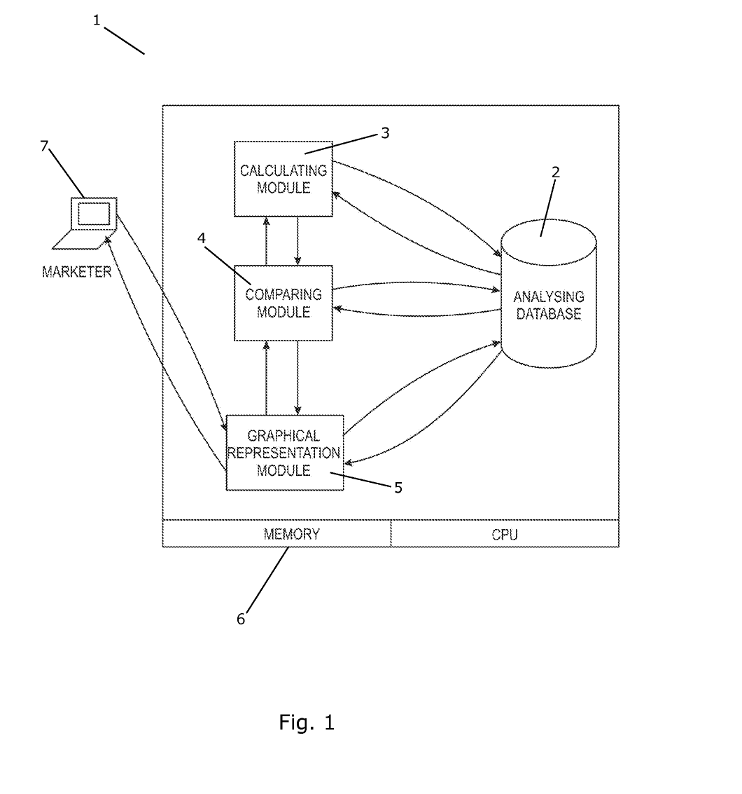

FIG. 1 is a diagrammatic view of a system 1 according to a first embodiment of the invention. The system 1 is suitable for being used for managing advertising campaigns. The system 1 comprises an analysing database 2, a calculating module 3, a comparing module 4 and a graphical representation module 5, all residing on a server 6. The server 6 could be a single device, or it could be two or more separate devices being interlinked in a manner which allows the separate devices to communicate in such a way that they act as a single device.

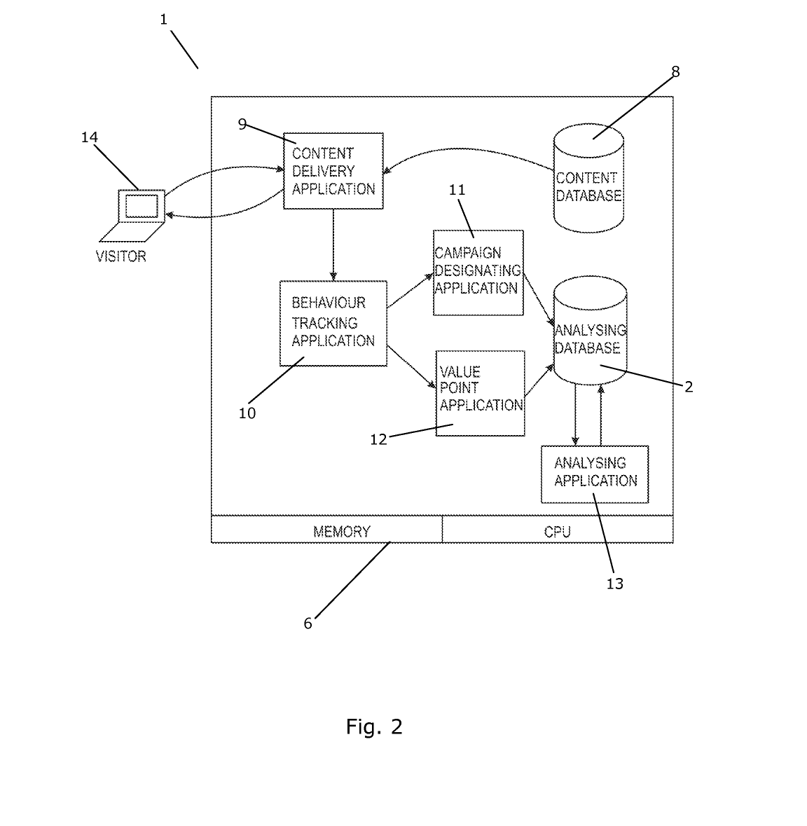

The analysing database 2 contains information regarding value generated by visitors which have visited a website, as well as regarding which previous advertising campaigns gave rise to the visits. This information has previously been collected, e.g. in a manner which will be described in further detail below with reference to FIG. 2.

The calculating module 3 accesses the information stored in the analysing database 2. For each of a plurality of previous advertising campaigns, the calculating module 3 calculates an accumulated value point score for the advertising campaign as the sum of value point scores for all visits designated to the advertising campaign. The calculating module 3 also calculates the number of visits designated to each of the advertising campaigns.

The calculated accumulated value point scores and number of visits are communicated to the comparing module 4. The comparing module 4 compares the previous advertising campaigns by comparing the information received from the calculating module 3. The comparing module 3 may further compare attributes, elements or themes of the advertising campaigns, as described above.

The result of the comparison performed by the comparing module 4 is communicated to the graphical representation module 5. Based on this, the graphical representation module 5 generates a graphical representation of the advertising campaigns, in particular reflecting the performed comparison.

A marketer accesses the graphical representation module 5, via a marketer device 7, and the marketer is thereby able to view the graphical representation generated by the graphical representation module 5. In FIG. 1 the marketer device 7 is illustrated as a personal computer (PC), but it should be noted that the marketer device 7 could alternatively be a cell phone, a tablet, a TV, or any other suitable kind of marketer device allowing the marketer to access the graphical representation module 5.

Based on the graphical representation presented to the marketer in this manner, the marketer plans a new advertising campaign to be launched. Thus, the new advertising campaign is designed on the basis of actual behaviour of visitors which accessed the website, due to previous advertising campaigns. Thereby experience gained from the previous advertising campaigns is exploited when designing the new advertising campaign, and the new advertising campaign is therefore very likely to fulfil marketing goals or strategies.

The comparing module 4 may further be adapted to generate a suggestion for at least one course of action for a new advertising campaign. In this case the suggestion is communicated to the graphical representation module 5, and is presented to the marketer, via the marketer device 7, along with or as a part of the graphical representation generated by the graphical representation module 5.

As indicated by the arrows shown in FIG. 1, the marketer may communicate with the graphical representation module 5, via the marketer device 7, e.g. in order to request analysis of collected data, request a particular graphical representation of a comparison, etc. Furthermore, each of the calculating module 3, the comparing module 4 and the graphical representation module 5 can communicate directly with the analysing database 2 in order to receive as well as provide data from/to the analysing database 2. Finally, the graphical representation module 5 can provide data or requests to the comparing module 4, and the comparing module 4 can provide data or requests to the calculating module 3.

FIG. 2 is a diagrammatic view of a system 1 according to a second embodiment of the invention. The system 1 is suitable for being used for managing advertising campaigns, in particular for collecting information regarding impact of previous advertising campaigns. The system 1 comprises a content database 8, a content delivery application 9, a behaviour tracking application 10, a campaign designating application 11, a value point application 12, an analysing database 2 and an analysing application 13, all residing on a server 6. The server 6 could be a single device, or it could be two or more separate devices being interlinked in a manner which allows the separate devices to communicate in such a way that they act as a single device.

A visitor accesses the content of a website via a client device 14. The visit performed by the visitor was occasioned by an advertising campaign which was launched previously. For instance, the visitor may have activated a link in an advertising e-mail, clicked a banner ad, entered a code indicated in a TV spot or a printed ad, etc., thereby linking the visit to a specific advertising campaign.

The content delivery application 9 delivers content to the client device 14 upon request from the visitor, thereby allowing the visitor to view desired content and/or perform desired actions within the website. The content is supplied to the content delivery application 9 by the content database 8. In FIG. 2 the client device 14 is illustrated as a personal computer (PC), but it should be noted that the client device 14 could alternatively be a cell phone, a tablet, a TV, or any other suitable kind of client device allowing the visitor to access the website content.

While the visitor navigates the website, the behaviour tracking application 10 monitors the navigations and/or actions performed by the visitor. During this, the behaviour tracking application 10 and the value point application 12 in cooperation accumulate value points for the visit. The value points are accumulated in accordance with the content viewed by the visitor and/or actions performed by the visitor during the visit. Previously, the content of the website has been associated with value point settings reflecting the value generated for the website owner when a visitor encounters specific content of the website. Thus, when a visitor views a specific piece of content or performs a specific action, value points corresponding to the viewed content or performed action are added to the value point score for the visit. Accordingly, when the visit is completed, a value point score for the visit has been obtained, and the value point score represents the value generated for the website owner during the visit. The obtained value point score for the visit is communicated to the analysing database 2 and stored there.

Simultaneously, the campaign designation application 11 registers which advertising campaign occasioned the visit. This information is also communicated to the analysing database 2 and stored along with the value point score for the visit. Accordingly, corresponding information regarding value point score and advertising campaign is stored in the analysing database 2.

The process described above is repeated for a plurality of visitors. Thereby the analysing database 2 contains information regarding a plurality of visits and regarding a plurality of advertising campaigns. The analysing database 2 communicates this information to the analysing application 13, and the analysing application 13 analyses the information. The analysing application 13 may advantageously include the calculating module 3, comparing module 4 and graphical representation module 5 illustrated in FIG. 1. A marketer may subsequently access the analysing application 13, e.g. in the manner described above with reference to FIG. 1, in order to gain knowledge regarding the impact of previous advertising campaigns on the value generated for the website owner. Based on this knowledge, the marketer can plan a new advertising campaign.

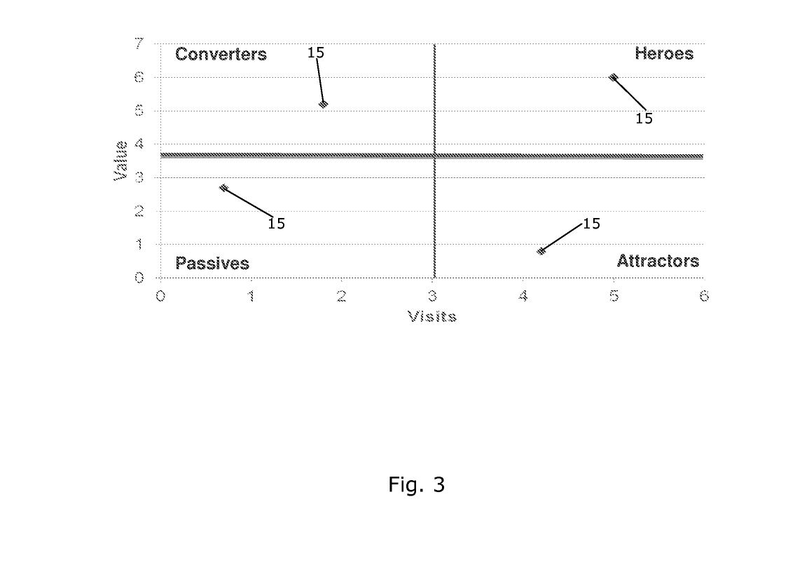

FIG. 3 is a graphical representation generated by a system according to an embodiment of the invention. The system may, e.g., be of the kind illustrated in FIG. 1 and/or of the kind illustrated in FIG. 2.

The graphical representation of FIG. 3 is in the form of a matrix, showing number of visits along a first axis and generated value along a second axis. The matrix is divided into four quadrants. Based on an analysis performed in accordance with the present invention, a plurality of advertising campaigns can be represented in the matrix. In FIG. 3 four advertising campaigns 15 are represented, one in each quadrant. The advertising campaigns 15 are plotted in the matrix in such a manner that the horizontal position reflects the number of visits which were occasioned by the advertising campaign, and the vertical position reflects the value point scores generated during all of these visits. Thus, the advertising campaigns arranged in the ‘Passives’ quadrant have a low number of visitors and a low accumulated value point score. The advertising campaigns arranged in the ‘Attractors’ quadrant have a high number of visitors and a low accumulated value point score. The advertising campaigns arranged in the ‘Converters’ quadrant have a low number of visits and a high accumulated value point score. Finally, the advertising campaigns arranged in the ‘Heroes’ quadrant have a high number of visitors and a high accumulated value point score.

The matrix shown in FIG. 3 provides a quick overview for a marketer regarding the impact of previous advertising campaigns. Thereby it is easy for the marketer to select advertising campaigns to be compared in order to investigate how a future advertising campaign should be designed in order to fulfil specific marketing goals or strategies. It is also easy for the marketer to identify campaigns to be investigated further in order to identify elements or attributes of the previous campaigns and understand how to change those elements or attributes to shift the previous campaign into another quadrant. For instance, if it is desired that a future advertising campaign results in a high number of visitors, the marketer might consider using attributes, elements, themes or distribution channels which were used in the advertising campaigns arranged in the ‘Attractors’ quadrant or in the ‘Heroes’ quadrant, and/or to avoid attributes, elements, themes or distribution channels which were used in the advertising campaigns arranged in the ‘Passives’ quadrant or in the ‘Converters’ quadrant. Similarly, if it is desired that a future advertising campaign results in a high accumulated value point score, the marketer might consider using attributes, elements, themes or distribution channels which were used in the advertising campaigns arranged in the ‘Converters’ quadrant or in the ‘Heroes’ quadrant, and/or to avoid attributes, elements, themes or distribution channels which were used in the advertising campaigns arranged in the ‘Passives’ quadrant or in the ‘Attractors’ quadrant.

Another embodiment of this visual representation is to display on the four quadrants the advertising attributes rather than advertising campaigns. Or to show the advertising campaigns overlaid with a representation of the campaign attribute such as text or color. This embodiment allows the observer to see multiple segments of attributes at one time and identify which segment produces the affect in the quadrant they desire. For example, advertising campaigns could be displayed as previously described, but in this embodiment the dot representing each campaign could be a different color dependent upon its marketing theme. In this case, marketing theme is an advertising message which might be transmitted in different ways.

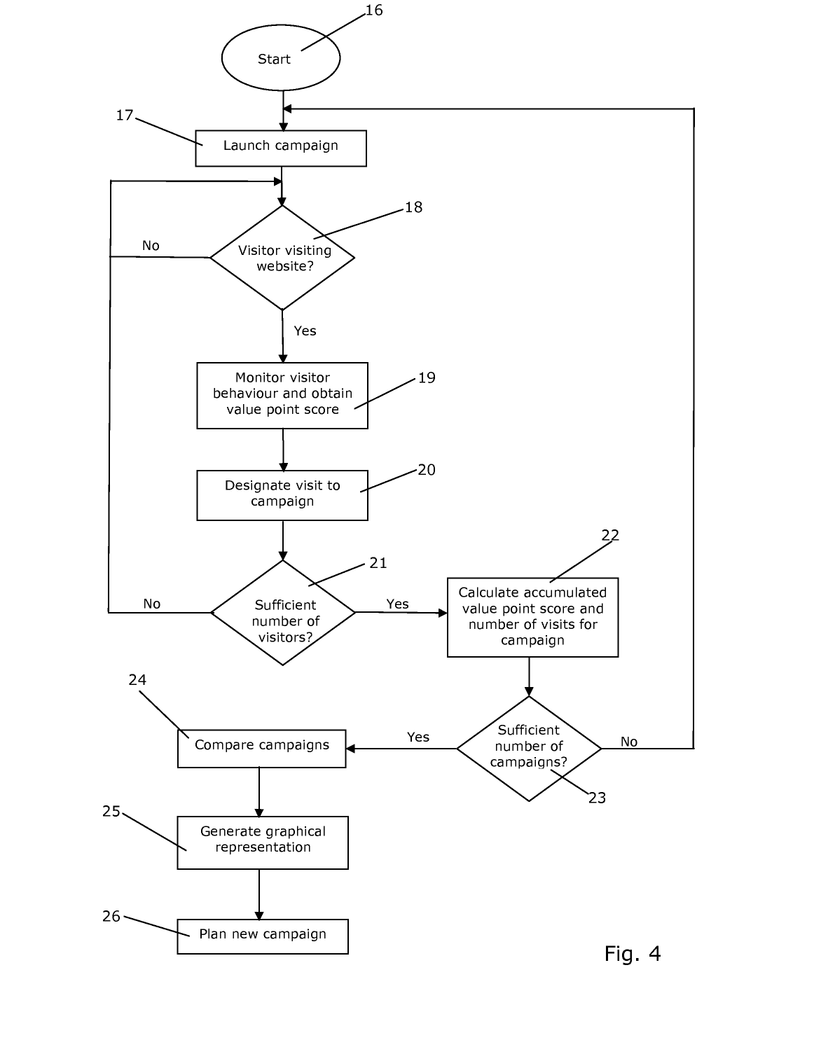

FIG. 4 is a flow diagram illustrating a method according to an embodiment of the invention. The process is started at step 16. At step 17 an advertising campaign is launched. At step 18 it is investigated whether or not a visitor is visiting a specific website. If this is not the case, the process is returned to step 18, i.e. the website is monitored until a visitor is detected.

If step 18 reveals that a visitor is visiting the website, the behaviour of the visitor is monitored at step 19. This results in a value point score being obtained. The value points are accumulated in accordance with content viewed by the visitor and actions performed by the visitor, and in accordance with predefined value point settings associated with the content of the website. The value point settings have been assigned to the content previously, e.g. when the content was created, by the website owner or manager. The value point settings are selected in such a manner that they reflect value generated for the website owner when a visitor views specific content or performs specific actions. When a visitor visits the website, a value point score is accumulated by continuously adding values defined by the value point settings. Thus, when a visitor views a specific piece of content or performs a specific action, the value point setting associated with that specific piece of content or action is added to the value point score of the visit. When the visit is completed, a value point score has been generated, and the value point score reflects the total value generated for the website owner during the visit.

At step 20 the visit is designated to an advertising campaign. The visit is designated to an advertising campaign which is considered as giving rise to the visit. The advertising campaign may, e.g., be identified by registering that the visitor activated a link in an advertising e-mail, clicked a banner ad, keyed in a code communicated in a TV spot or a printed ad, etc.

It should be noted that the sequence of steps 19 and 20 is not essential in the sense that they may be performed in any desired order. Steps 19 and 20 may even be performed substantially simultaneously.

At step 21 it is investigated whether or not a sufficient number of visitors have visited the website, i.e. whether or not a sufficient number of accumulated value point scores and designation of campaigns have been obtained. If this is not the case, the process is returned to step 18 in order to obtain further data. In the present context the term ‘sufficient’ should be interpreted to mean that the number of visitors having visited the website is high enough to allow statistical analysis to be performed on the obtained data. For instance, the number of visitors could correspond to a given fraction of a given population of visitors, the fraction providing an acceptable confidence level in the subsequent analysis.

If step 21 reveals that a sufficient number of visitors have visited the website, an accumulated value point score and number of visits for the advertising campaign are calculated at step 22. The number of visits for a given advertising campaign is the number of visits which have been designated to that advertising campaign, and the accumulated value point score is the sum of the value point scores for these visits.

At step 23 it is investigated whether or not a sufficient number of advertising campaigns have been investigated in the manner described above. If this is not the case, the process is returned to step 17, i.e. a new advertising campaign is launched. It should be noted that two or more advertising campaigns may be running simultaneously, i.e. the advertising campaigns need not be launched sequentially.

If step 23 reveals that a sufficient number of advertising campaigns have been investigated, the investigated advertising campaigns are compared at step 24. The comparison includes comparing the calculated accumulated value point scores and number of visits of the advertising campaigns. The comparison may further comprise comparing attributes, elements or themes of the advertising campaigns. Based on this comparison, a graphical representation is generated at step 25. The graphical representation is presented to a marketer. At step 26 the marketer plans a new advertising campaign, based on the graphical representation generated at step 25.

1. A method for managing advertising campaigns, the method comprising the steps of:
launching a plurality of advertising campaigns,
allowing a plurality of visitors to visit a website, said website being arranged on a server,
for each visit:
designating the visit to an advertising campaign,
monitoring navigations and/or actions performed by the visitor during the visit while accumulating value points in accordance with content viewed by the visitor and actions performed by the visitor, and in accordance with predefined value point settings associated with content of the website, thereby obtaining a value point score for the visit,
for each advertising campaign:
calculating an accumulated value point score for the advertising campaign as the sum of value point scores for all visits designated to the advertising campaign,
calculating the number of visits designated to the advertising campaign,
comparing the plurality of advertising campaigns, including comparing accumulated value point scores and number of visits for the plurality of advertising campaigns, and
based on the comparing step, planning a new advertising campaign.

2. A method according to claim 1, wherein at least one of the advertising campaigns is a web-based advertising campaign.

3. A method according to claim 1, further comprising the step of generating a graphical representation of the accumulated value point scores and number of visits for the plurality of advertising campaigns, and wherein the step of comparing is performed using the generated graphical representation.

4. A method according to claim 3, wherein the graphical representation comprises a matrix representation.

5. A method according to claim 1, wherein the step of planning a new advertising campaign comprises reusing attributes or elements from one or more of the plurality of advertising campaigns.

6. A method according to claim 1, wherein the comparing step comprises categorising each of the plurality of advertising campaigns, based on the accumulated value point scores and the number of visits.

7. A method according to claim 1, wherein the comparing step is performed by a comparing module, and wherein the method further comprises the step of the comparing module suggesting at least one course of action for a new advertising campaign, based on the comparing step.

8. A method according to claim 7, wherein the comparing step is performed using artificial intelligence.

9. A method according to claim 7, wherein the suggesting step comprises identifying one or more campaigns and/or one or more attributes or elements of a campaign to be changed.

10. A method according to claim 1, further comprising the step of:
based on the comparing step, generating attributes that define best practices for advertising campaigns.

11. A system for managing advertising campaigns, the system comprising:
a server having a website arranged thereon,
a monitoring module adapted to monitor navigations and/or actions performed by a visitor during a visit to the website, said monitoring module further being adapted to accumulate value points in accordance with content viewed by the visitor and actions performed by the visitor, and in accordance with predefined value point settings associated with content of the website, thereby obtaining a value point score for the visit, and being adapted to designate the visit to an advertising campaign,
a calculating module adapted to calculate, for each of a plurality of previously launched advertising campaigns, an accumulated value point score, being the sum of value point scores for visits designated to the advertising campaign, and the number of visits designated to the advertising campaign,
a graphical representation module adapted to generate a graphical representation of accumulated value point scores and number of visits for the plurality of advertising campaigns.

12. A system according to claim 11, further comprising a comparing module adapted to compare accumulated value point scores and number of visits for the plurality of advertising campaigns.

13. A system according to claim 12, wherein the comparing module is further adapted to generate a suggestion for at least one course of action for a new advertising campaign, based on a comparison performed by the comparing module.

14. A system according to claim 12, wherein the comparing module is adapted to perform comparison by means of artificial intelligence.

15. A system according to claim 11, further comprising an advertising planning module arranged to plan a new advertising campaign based on a graphical representation generated by the graphical representation module.
